(19) United States
(12) Patent Application Publication
(10) Pub. No.: US 2008/0040232 A1
(43) Pub. Date: Feb. 14, 2008

(54) METHOD FOR PERFORMING A NETWORK AUCTION

(76) Inventor: Dirk Perchthaler, Vierkirchen (DE)

Correspondence Address: DARBY & DARBY P.C., P.O. BOX 770, Church Street Station, New York, NY, 10008-0770, US

(21) Appl. No.: 11/464,400

(22) Filed: Aug. 14, 2006

(51) Int. Cl. G06Q 30/00

(52) U.S. Cl. 705/26

(57) ABSTRACT

The present invention relates to conducting an auction over an electronic network such as the Internet. In an exemplary embodiment, the auction is administered by a central computer, that enables a seller to enter listing information regarding an auction item and enables bidders to enter bids for the auction item. The seller may manually select a bid prior to expiration of a predefined auction period, even if the selected bid is not the highest. The seller may also enter one or more auction conditions desired of a bid and/or bidder. The auction ends as soon as a bid by a bidder is entered that meets the auction conditions, even if the full auction period has not expired. A bidder may also enter a bid group of multiple bids to participate in multiple auctions for substantially similar auction items. If one bid is accepted, the other bids are cancelled.

### FIELD OF ART

1. Field of the Invention

The invention relates to a method for conducting an auction over an electronic network such as the Internet.

2. Background

Internet auctions are becoming increasingly popular nowadays. In the meantime, auction houses of all kinds exist on the Internet.

On the one hand, the auction house can act as an intermediary, thus giving private persons the possibility to enter into purchase agreements for used items or new products. On the other hand, the auction house can auction goods on behalf of third parties, for instance, for a dealer, or else it can auction its own goods on its own behalf.

Some Internet auctions offer multiple similar or identical articles concurrently. Due to the fact that the listings are offered concurrently, bidders are faced with the disadvantage that they have to choose a specific auction so as not to bid in such a way that they are at risk of submitting winning bids in several auctions, thereby being forced to purchase several won items.

Conversely, the bidder also repeatedly faces the risk that he might be overbid shortly before the end of the auction. This is particularly problematic when he needs an auction item at a specific point in time such as, for example, an airplane ticket or hotel accommodations.

Moreover, the classic Internet auctions entail the drawback for a bidder that there is competition between the bidders, as a result of which it can easily happen that bids are submitted that exceed the actual monetary value of the item being auctioned. This is sometimes referred to as a bidding frenzy.

Often, it is not only being overbid that is annoying but also being the highest bidder in an auction, since as long as one is the highest bidder, the bid remains binding. If the bidder suddenly sees the desired item cheaper elsewhere, he usually can only retract the bid under certain limited circumstances.

However, it is not only bidders but also sellers who face drawbacks with Internet auctions of the state of the art.

For example, the fact that an end is specified for an auction means that many bidders wait until the last possible moment to submit their bids. As a consequence, towards the end of a very popular auction, it can happen that an auction server is overloaded, which can mean that not all bidders are able to submit their bids. Moreover, due to this technique, which is called “sniping”, the amount of the bid is only made known at such a late point in time that—since the auction then ends almost immediately—other bidders no longer have a chance to submit a higher bid. As a result, it is often the case that sellers cannot get the selling price for their goods that they wanted to get in the auction.

Consequently, the seller runs the risk that he has to sell the item for the price of the highest auction bid, even if this is objectively not equal to the value of the listing.

The seller can offset this risk by specifying a longer predefined period of time for an auction, but this is only successful to a very limited extent, particularly due to the above-mentioned phenomenon that bids are delayed until just before the end of the auction.

Furthermore, the obligation arises that the highest bid has to be accepted, and this may mean that the seller has to accept a poorly rated or unwelcome bidder, even if this increases the risk that he will not receive his payment. With most auction houses, a cancellation of the bid is possible in exceptional cases, usually only during the listing time and up to 12 hours before the end of the auction. Therefore, since the bids are often only submitted shortly before the end of the auction, withdrawal from the auction by the bidder or seller is no longer possible.

### BRIEF DESCRIPTION OF THE DRAWINGS

Advantageous embodiments of the invention will be explained below with reference to the drawings, in which the following are shown: FIG. 1 a graphic depiction of a time course of bids for an auction listing,

FIG. 2 a course of auction conditions over time during an auction,

FIG. 3 acceptance of the bid of a bidder who is bidding in several auctions.

FIG. 4 one embodiment of a server, according to one embodiment of the invention, which uses a central computer.

### DETAILED DESCRIPTION

It is an object of the present invention to overcome the above-mentioned disadvantages that occur in electronic auctions of the state of the art.

In one embodiment, the present invention provides a method for conducting an auction over an electronic network, such as the Internet, whereby the auction is administered by a central computer, said method comprising the step that a seller enters listing information via a first terminal, whereby the listing information is transmitted to the central computer and stored there, optionally the step that the seller enters one or more auction conditions (shown as element B in the figures) via the first terminal, whereby the auction condition (B) determines when a bidder wins the auction with his bid, and whereby the auction condition (B) is stored by the central computer, said method also comprising the step that the seller starts the auction for a predefined period of time, and comprising the step that the auction ends as soon as a bid by a bidder is entered via a second terminal and this bid meets the auction conditions (B) of the seller or else the step that the auction ends as soon as the seller manually accepts a bid from a bidder. The auction can also end, if no bid was entered or entered bids were not accepted, and the expiration date of the auction passed.

A seller can offer items, services, rights, real estate, etc. for sale to bidders on an online platform, and both sellers and bidders can transact the deal, irrespective of their actual locations.

In a particular embodiment, the auction is conducted over the Internet by a central computer that includes a plurality of appropriate server computers. The large number of appropriate server computers ensures that, in times of high server traffic or in case of a server malfunction, the Internet auctions can be reliably transacted.

To enter listing information about an auction item, a seller logs in on a homepage of the online platform with his user ID and with his password and can then offer a new listing on a seller's page. When the seller registers, he receives his user ID and password from the online platform that is offering the Internet auction. The user ID and password are stored in the central computer. During this registration process, the seller will preferably have provided his particulars such as name, address, phone number and e-mail address, which are stored by the central computer of the online platform. When the seller logs in, the central computer compares the stored user ID and the stored password to the user ID and the password entered during the log-in procedure. If they match, the procedure of logging in to the online platform was successful.

In one embodiment, the term “listing” may refer to features of a product, a used item, a travel offer, a service, ride-sharing, a real estate object, and the like. In case of a travel offer, the seller enters additional details about the travel offer via a seller client, such as a first terminal. This more detailed description generally comprises features such as the destination, the type of accommodations, the length of the stay, the desired price, the number of persons traveling, etc. By the same token, the seller can include a photograph of the offer being auctioned so that the bidder can get a better notion of what is being offered.

The first terminal may be a computer, a laptop, a cordless phone, a cell phone, a PDA (Personal Digital Assistant), or the like, that allows a connection with the central computer via a wireless connection, a conventional phone line or a data line.

The entered description of the seller's auction listing is converted by the first terminal into appropriate data bits and data bytes and transmitted by means of a wireless connection, a conventional phone line, a data line, or other communication means to the central computer that includes a plurality of server computers.

After the entry has been made, the information pertaining to the auction listing is stored in the central computer, and is then available to many auction members, that is to say, bidders, on the Internet. The auction members merely need a second terminal that can establish a wireless connection, a connection via a conventional phone line, via a data line, or the like, with the online platform on the Internet. Once this second terminal has established a connection with the online platform, the second terminal can retrieve the information about the listing of the seller that is stored in the central computer and can display this information on the second terminal

Concurrently, or in a subsequent step, the seller can enter one or more auction conditions (B) via the first terminal. An auction condition may include a bidder profile of a desired bidder, a desired auction price, a desired purchase quantity of the auction listing, or other conditions of sale. In prior art auctions, a bidder wins an auction simply by submitting the highest bid. The seller generally can not impose any other conditions. However, embodiments of the present invention enable the seller to specify conditions other than simply selecting the highest bidder. The entry of an auction condition is optional. Fundamentally, the seller can also place the listing without auction conditions (B), but then he generally would check periodically and, if necessary, accept bids manually. By means of an auction condition (B) requiring a bidder profile, it is possible to ascertain how old a bidder should be, how many positive feedback points he has already received from other sellers and buyers in Internet auctions on this online platform, where the bidder lives, where the auction item should be sent after the end of the auction, how positively rated the bidder is, the price the bidder has to offer, how many days are left until the end of the auction, etc. By entering the auction condition (B), the seller has more control to determine when a bidder wins an auction with his bid. In one embodiment, the auction condition (B) has the result that a submitted bid of a bidder that meets the auction condition (B) is automatically accepted by the auction platform on behalf of the seller immediately after being submitted.

However, it can also happen that a bid surpasses the auction conditions of the seller, that is to say, if the seller has set an auction condition (B) for an item stating that the bid is to be accepted at bids above a price of £100 and if a bidder bids £200, then the bid is immediately accepted at £200, and the bid is automatically accepted by the central computer of the online platform.

In one embodiment, during a predefined period of time, the seller has the possibility to change the auction condition after a certain point in time. This can be, for example, that for the first three days, the auction condition B1 applies with a certain price, a certain quantity, a certain number of ratings. Starting on a fourth day, an additional auction condition B2, for example, with a lower price, applies until the end of the auction. In this process, the first auction condition B1 remains in force. Thus, the seller has the possibility to already sell an item at the auction condition B2 if, by the fourth day, no bids have been submitted that have met the auction condition B1. Alternatively, multiple conditions can be entered at the start of the auction, and/or added throughout the auction. The conditions can be effective immediately or set to become effective at a predefined time, after a predefined length of time, and/or upon detection of an event.

The term “bid” generally refers to an offer submitted by a bidder that the bidder is willing to pay a certain price for the listing offered by the seller. In order for a bidder to be able to submit a bid, he likewise registers with the online platform, as already described for the seller. By means of the user ID and password selected at the time of the registration, the bidder logs in on the online platform for Internet auctions and can submit a bid for a listing that appeals to him. For this purpose, he can preferably enter the maximum price he is willing to pay or the number of items in the seller's listing he would like to buy. The information provided by the bidder via the second terminal, such as the price and quantity, are transmitted over the network to the central computer of the online platform and stored by the central computer. At the time of registration or at the time of submitting a bid, he also submits his bidder profile, which is stored in the central computer and may be updated whenever the bidder buys or sells on this online platform.

If, as the auction progresses, the bid of a bidder meets the auction conditions (B) of a seller, then this bidder wins the auction for the listing offered for this auction.

Once the seller has entered the auction conditions (B) via the first terminal, these conditions are generally stored by the central computer, by a related remote storage computer, or the like.

The seller may click on a button “Start Auction” on his seller's web page or the homepage of the online platform, or otherwise start the auction. By the same token, the seller also has the possibility to specify in advance when the auction should start. The auction is then automatically opened by the system at a specific point in time and it runs for a predefined period of time. As a result, it is no longer necessary for the seller to log in on the homepage of the online platform at the desired point in time in order to start the auction.

The predefined duration of the auction can preferably be 1 day, 3 days, 5 days, 7 days, 10 days, etc. and is specified by the seller himself.

During this predefined period of time, bidders who log in to the homepage of the online platform via the second terminal by entering a password and user ID can submit a bid for the listing offered by the seller.

The data about the bids of the bidder are transmitted by a bidder client, such as the second terminal, to the central computer with its plurality of server computers and stored there. Likewise, the central computer determines which submitted bids only partially meet the auction conditions of the seller and which bids have been retracted. Moreover, the central computer uses auction software that is running on the central computer to detect when all of the auction conditions (B) have been met by a bid of a bidder in that the submitted bids are compared to the stored auction conditions of the seller.

As soon as the auction conditions (B) of the seller have been met, that is to say, if a bidder has submitted a bid via a second terminal that meets the auction conditions (B) of the seller, the auction is automatically ended by the central computer and the bidder wins the auction for the offered listing.

By the same token, the auction is ended in that the seller himself, before the end of the predefined period of time, actively and manually accepts the bid of a bidder, thus ending the auction prematurely. For this purpose, the seller logs in on the homepage of the online platform with his user ID and password and visits his seller's page. There, the seller can view a list of the bids that have been placed for the individual listings. He opens the bid that he wishes to accept manually and clicks on the button “accept bid”. If the seller clicks on this button “accept bid”, the bidder whom the seller has selected wins the auction.

The seller can also explicitly reject a bid. The bidder is informed to this effect and can rectify his bid and thus reactivate it. The term “rectify” generally means that the bidder submits a higher bid for the item being offered.

The second terminal of the bidder may be a computer, a laptop, a cordless phone, a cell phone, a PDA (Personal Digital Assistant), or the like, that allows a connection to the Internet via a wireless connection, a conventional phone line, a data line, or other communication means in order to submit a bid in the auction.

After the end of the auction, both the seller and the buyer are notified about the end of the auction in that an automatic e-mail is generated by the central computer that informs the seller as well as the buyer about the end of the auction and about the acceptance of the bid.

In another embodiment, the present invention may be used for “multiple item auctions”, in which multiple items are auctioned. For example, 100 concert tickets are auctioned off. Then the auction does not end when a bid is for less than 100 tickets but rather when no more tickets are available or when the end of the auction time has been reached.

In another advantageous embodiment of the present invention, it is provided that the auction is ended when the seller cancels his listing, when no bid is submitted for the offered listing within a predefined period of time or when, after the predefined period of time has expired, none of the submitted bids meets the auction conditions of the seller and the seller has not accepted any bids manually.

By the same token, the seller can cancel his sales listing at a certain point in time, thereby ending the auction. For this purpose, the seller once again logs in on his seller's page of the online platform as described above and clicks on a button “change listing” or “cancel listing”. After clicking on the button “change listing” or “cancel listing”, the seller can decide whether he merely wishes to change his listing or whether he wants to completely remove the listing from the online platform. After removing or changing the auction, the seller then clicks the button “store” to confirm the removal or change of the auction. The central computer stores the changes made to the listing of the seller.

It is also possible that during the auction, within the predefined period of time, not a single bidder submits a bid since the listing is not what they are looking for. In this case, the central computer automatically ends the auction after the predefined period of time has expired. At the same time, after the end of the auction, the central computer notifies the seller about the end of the auction and inquires whether the auction listing is to be offered for sale once again on the online platform.

In another case, it is possible that the bids submitted by the bidders do not meet the auction conditions (B) of the seller and that consequently no bid is accepted during the predefined period of time. Within a definable time span before the end of the auction, the seller is informed by the system of the online platform that bids are present that do not meet the auction conditions (B) and that the auction will soon be ending. Moreover, the seller is informed by the system that the bids will lapse if the seller does not accept any of the bids that do not meet the auction conditions (B). If the seller does not accept any of the bids, then the central computer automatically ends the auction after the predefined period of time has expired. By the same token, the central computer asks the seller if he would like to offer the listing for sale once again.

But, the seller also has the possibility to get into contact with the bidder after the auction via the online platform and can offer that he will start the auction again and that he will then immediately accept the bidder's offer. However, this is a so-called “manual” procedure and may be independent of the system of the online platform.

In another advantageous embodiment of the present invention, it is provided that the auction condition (B) contains at least one feature from the group comprising: price, quantity, bidder profile.

In this context, the feature “price” generally refers to a minimum selling price that the seller would like to get for the item he has listed for auction on the Internet. If the bid of the bidder falls below this price, the bid will not win the listing offered by the seller.

The feature “quantity” generally indicates that the seller wants one or more bidders to buy a certain number of the items. For example, the seller may desire to sell three of twenty available seats on a flight or four movie tickets out of 100 available tickets. If this quantity is not met on the part of the bidder, the bid will not win the listing offered by the seller.

The feature “bidder profile” generally refers to a personal identity of the bidders, such as their age, their gender, how many positive feedback points they have already received on the online platform for Internet auctions from other auction members, where they live, the monetary value of what they buy and sell each month on this online platform for Internet auctions, etc.

In another advantageous embodiment of the present invention, it is provided that the feature “price” generally refers to a minimum price that the seller would like to get for his listing in the auction. If the bidder does not meet the minimum price, which is also one of the auction conditions, then the bidder's bid is not accepted for the auction listing of the seller. However, if the minimum price is met, then the auction is immediately won by the bidder who was first to bid this auction price desired by the seller and who was first to meet other auction conditions of the seller, regardless of how long the predefined period of time of the auction would have been.

In another embodiment of the present invention, it is provided that the feature “quantity” generally refers to a minimum quantity or a maximum quantity that the seller is listing on the auction and that a bidder will buy after the end of the auction. In this embodiment, the minimum quantity is the quantity that the bidder has to buy from the seller in any case, if his bid is accepted. The maximum quantity is the highest quantity that the seller will sell. In this case, a larger quantity for the bidder is not possible. If this feature is met along with other auction conditions desired by the seller, then the bidder immediately wins the auction.

In another advantageous embodiment of the present invention, it is provided that the feature “bidder profile” generally refers to which bidders the seller wants to participate in the auction. Thus, the seller can preferably specify in advance that he only wishes to make transactions with certain bidders in order to avoid later annoyance with unreliable bidders, so-called disruptive bidders, and the like.

In another advantageous embodiment of the present invention, it is provided that the bidder profile includes: age, gender, ratings, location, and/or other information about a bidder. Thus, the seller can preferably specify in advance that he only wishes to make transactions with certain bidders, for example, with bidders who have a positive feedback score of at least 100 and not a single negative feedback, in order to avoid later annoyance with unreliable bidders.

In another advantageous embodiment of the present invention, a combination of criteria may be specified by the seller. For example, a “price” along with a “quantity” and/or a “bidder profile” may be specified by the seller as the auction condition. Thus, for example, it may be preferred for the feature “price” to be met together with the feature “quantity”, that is to say, the seller wants to get a specific price for his auction listing and, at the same time, wants to sell at least a certain quantity of the items in the listing to a bidder after the end of the auction.

Moreover, it may be preferred for the feature “price” to be met together with the feature “bidder profile”, that is to say, the seller wants to get a specific price for his auction listing and, at the same time, wants to offer the auction listing only to a certain preferred group of bidders so that, right from the start, he prevents any subsequent irregularities in transacting the deal.

In another advantageous embodiment of the present invention, it is provided that the predefined period of time starts immediately or else at a later selectable point in time and this can be specified individually in terms of days, hours, minutes and seconds. Thus, the seller can preferably set the point in time when his auction is to start. At the same time, he can preferably specify the time span for an auction, for example, in order to select a point in time at which he would like to monitor the end of the auction.

In another advantageous embodiment of the present invention, it is provided that, in case successful bids of several bidders are accepted at the same time, the central computer determines on a random basis whose bid will be accepted. This prevents the bids of several bidders from being accepted if the seller is only offering one item.

In another advantageous embodiment of the present invention, it is provided that, during the predefined period of time of the auction, a bidder may concurrently submit a grouped bid for several similar listings.

The term “concurrently” generally refers to a certain window of time, for example, three days, the bidder bids simultaneously in several auctions, whereby the auctions preferably have different auction durations and substantially similar listings.

“Equivalent listings” generally refer to listings that are highly similar. For example, if the bidder is bidding for an overnight stay in Munich in a certain hotel of a certain category, then this listing is equivalent to another listing of an overnight stay in Munich in another hotel of the same category and hence it is highly similar.

“Grouped bidding” generally refers to a bidder submitting his bid virtually simultaneously for different listings in different auctions. In order to group bids, a so-called “bid group” may be set up to which individual bids are assigned immediately when they are created or else at a later point in time. Thus, the bidder can, for example, set up a bid group for a “weekend in Munich”, a “flight to Munich” and a “bicycle”. Moreover, he can submit individual bids to different auctions that are being held concurrently or at a different point in time.

If the bidder has, for example, won an auction for a weekend in Munich, then all of the bids that he has submitted in this group are at once retracted by the central computer. Once he has won an auction for the desired bicycle, the bids for other bicycles are also retracted from the system. And once he has won his flight to Munich, the rest of his bids in the bid group “flight to Munich” are retracted. Grouping of bids generally makes it possible to have individual bids concurrently. Likewise in bid groups, the individual bids can have different values and quantities. Generally, the extra bids are retracted immediately after a bid from the group has won. The retracted bids may stay in the system and may be used for reference, or may even be reactivated if the bidder desires multiple items and/or if an error occurs with the first winning bid.

It is likewise possible for a buyer to visit different auctions before submitting a bid to various auctions in order to get an impression of the listings of several sellers. Here, he has the possibility to use a button “mark auction” that is displayed on the auction page of a listing placed by a seller so that the central computer will store this page for the bidder on his bidder's page. The bidder can take this approach for numerous listings that interest him and can store these interesting listings on his bidder's page. At the same time, the bidder can indicate on his bidder's page that he would like to bid on the marked auction listings at his desired conditions (price, quantity) immediately or else at a later point in time. For instance, if the bidder clicks on the button on his bidder's page titled “bid on all listings”, then the central computer bids simultaneously on all of the listings that the bidder has marked and at the conditions that the bidder has specified. As soon as the central computer ascertains at the various auctions that the bidder has met all of the auction conditions of a seller or that a seller is in agreement with one of the bids placed by the bidder, the central computer accepts the bid of the bidder as the winning bid for this auction. At the same time, all of the further bids of the bidder that have been submitted for the rest of the marked auctions are automatically retracted by the central computer. This prevents the bids of the bidder from being accepted at multiple auctions in which he submitted bids if he indicated that he only wanted to buy one listing.

By the same token, with an embodiment of the present invention, the bidder—via his bidder's page on the homepage or other portion of the online platform for Internet auctions—can specify features of seller's listings that meet certain auction conditions. If the bidder, for example, is looking for a trip to Italy for two persons from Apr. 14, 2006 to Apr. 28, 2006 and the bidder would like to depart from the Munich airport, then the bidder can enter these features via the second terminal. Moreover, the bidder can enter that the trip for two persons should cost £1500 at the maximum and that he would like to stay in a 4-star hotel in Naples.

In response to this, the central computer locates the auctions stored on the online platform that meet the requirements of the bidder, and it submits a bid at the auction conditions (B) specified by the bidder to all of the auctions it has located. As soon as the central computer or a seller has accepted a bid of the bidder for one of the listings that meets his requirements, the remaining bids of the bidder are retracted from the other auctions. Then the seller and the buyer are notified about the end of the auction and the pertinent contact addresses are exchanged for purposes of enabling a quick transaction of the auction listing.

By the same token, in another embodiment, the bidder can use his bidder's page of the online platform for Internet auctions to specify the desired features of future auction seller listings that meet certain auction conditions. If, for example, the bidder would like to book a trip that is scheduled for six months from now, he can store his interest in a certain listing at certain auction conditions on his bidder's page on the central computer. Then, if so desired, the central computer also bids on future auctions, which saves quite a bit of time for the bidder.

In another embodiment of the present invention, it is preferred that the bidder can also indicate on his bidder's page that, in the future, he would also like to automatically bid with a seller at specific auction conditions if he has already once before had a bid accepted by this seller for an auction listing. The bidder can store his specifications on his bidder's page. The central computer then also bids automatically in future auctions if so desired, which saves quite a bit of time for the bidder.

In another advantageous embodiment of the present invention, it is provided that the bid of a bidder is automatically retracted by the central computer if the bidder has had a bid accepted for a similar listing in another auction that is running concurrently.

A process of automatically retracting a bid generally includes, as soon as a bid from a bid group has been accepted, the central computer immediately retracts the other bids in this bid group. In this manner, it is avoided that the bidder buys several listings at the same time since he only wants to buy one auction listing.

In another advantageous embodiment of the present invention, the bidder can retract his bid as long as the seller has not accepted his bid. Thus, the bidder can retract his bid for a certain listing from a certain seller via the second terminal if, for example, he has seen the same listing at a lower price or at better auction conditions on another auction or outside of the auction house, for example, in a travel agency. Generally, retraction occurs when the seller has not yet accepted the bid of the bidder.

In another advantageous embodiment of the present invention, after the end of the auction, the central computer informs the seller and the bidder about the end of the auction. The central computer may send an e-mail to the e-mail addresses provided by the seller as well as by the bidder and notifies other auction members about the end of the auction. The seller and the bidder can subsequently discuss the further course of action for transacting the deal.

In another advantageous embodiment of the present invention, it is provided that, during an auction, the seller has the possibility to modify the listing information and/or the auction conditions. After all, it can happen that the seller has made a mistake when entering the listing information and would like to modify it.

One or more other advantageous embodiments of the present invention can be used for an auction related to tourism, accommodations, ride-sharing centers, car rental agencies, and the like. In this manner, it is possible to use the auction conditions to filter which target audience one would like to address. Thus, for example, via ride-sharing centers, a seller can decide whether he will or will not accept a certain bidder who would like to ride with him as his passenger, for example, because he finds this person agreeable.

In another advantageous embodiment of the present invention, a system is provided that allows a connection between at least one first terminal, at least one second terminal and the central computer, via an Internet connection and/or Bluetooth connection and/or a wireless connection and/or any other combination of communication connections. In one embodiment, the first terminal and the second terminal are linked to the central computer via a wireless connection. This entails the advantage that the seller and the bidder can place their listings and bids irrespective of their locations and this embodiment can be employed flexibly for auctions.

### DESCRIPTIONS ASSOCIATED WITH THE FIGURES

Throughout FIGS. 1-3, a number of reference labels are used generally in accord with the following table:

A-G2 acceptance of the bid of the second bidder by the seller

| | |
|---|---|
| B1 | first auction condition |
| B2 | second auction condition |
| B3 | third auction condition |
| G1 | bid of a first bidder |
| G2 | bid of a second bidder |
| G3 | bid of a third bidder |

t time

| | |
|---|---|
| t₀ | start of the auction |
| t₁ | first point in time |
| t₂ | second point in time |
| t₃ | third point in time |
| t₄ | fourth point in time |
| t₅ | fifth point in time |
| t₆ | sixth point in time |

FIG. 1 shows a time course of an auction on the Internet using an embodiment according to the invention.

The figure shows a time axis t, a point in time t₀ at which the Internet auction of the seller V starts with his auction listing at the auction conditions B1, a first point in time t₁ at which a first bidder submits his bid G1, a second point in time t₂ at which the first bidder retracts his bid G1 since he is no longer interested in the listing of the seller V.

In addition, the figure shows a third point in time t₃ exists at which a second bidder submits his bid G2, a fourth point in time t₄ at which a third bidder submits his bid G3 and a fifth point in time t₅ at which the seller V actively accepts the bid G2 of the second bidder (A-G2).

In conclusion, FIG. 1 also shows a sixth point in time t₆ at which the auction would have automatically ended if no bidder had submitted a bid for the listing of the seller V or if no bidder had met the auction conditions B1 of the seller V, as a result of which the auction would have been automatically ended by a central computer.

In one embodiment of the present invention, at a point in time that lies before the point in time t₀, the seller V would like to use the first terminal to place an auction listing with pertinent listing information on an online platform that supports the method according to the invention.

The seller V is generally a seller who is already registered on the online platform for Internet auctions, that is to say, he already has a user ID and an associated password.

In a particular embodiment, the seller logs in on the homepage or other page of an online platform, such as a platform with a domain name of “www.Power-Sellers.de.” The seller may use a user ID such as “Travel Pro” and use a password such as “Trips.” In this process, his user-specific data is transmitted from the first terminal to the online platform. The first terminal may be a laptop that establishes a high-speed wireless Internet connection with the homepage of the online platform, which may be referred to as “Power-Sellers.”

The central computer verifies the data entered by the seller V by making a comparison with data already stored on the central computer that the seller V had already entered into the central computer at an earlier point in time.

Once the central computer has verified that the data entered by the seller V, that is to say, the user ID and the password, matches the data stored on the central computer, the seller is logged into the online platform for Internet auctions and, on the homepage of the online platform, a seller's page opens on which the seller V can enter auction listings as desired.

As an example, on March 27 at 10:30 a.m., the seller uses the first terminal to enter information about his listing on the homepage of the online platform for Internet auctions.

In this example, the listing that the seller “Travel Pro” would like to offer on the online platform is a weekend in Munich, from April 28 to May 1 with an overnight stay for two persons in a 5-star hotel. The seller describes his listing in detail, uses the first terminal to enter the price he would like to get for the listing and the bidder profile that the bidder should have.

The seller enters via his laptop that he is offering the entire package for the weekend in Munich in the 5-star hotel for two persons for the price of £299 if the bidder has a positive feedback score of at least 100 and no negative feedback. Moreover, the seller enters that he will accept a bid for £399 from a bidder who has a positive feedback score of only 95 and 5 feedback points negative at the most.

Furthermore, the seller enters that the bidder has to pick up the voucher for the weekend personally in Munich and that the seller wants payment in cash.

In conclusion, the seller also enters the starting price for his auction as well as the end of the auction, such as, April 15 at 12:00 noon, and he starts the auction at a price of £199 on March 27 at 12:00 noon.

The entered data of the seller is converted by the laptop into the appropriate data bits and bytes and is sent via the Internet connection to the central computer. Auction software of the central computer processes the appertaining data, stores it on the central computer and makes the seller's listing available to other bidders in HTML format on the homepage or other portion of the online platform “Power-Sellers” for internet auctions. In this example, interested bidders who visit the page www.Power-Sellers.de then have the possibility to read the stored information from the central computer via the second terminal and to display this graphically on the second terminal.

With the auction conditions B1 specified in this embodiment by the seller V, namely, the desired selling price, the number of positive feedback points, the pick-up of the voucher in Munich, the requirement of payment in cash, the auction starts to run from March 27 at 12:00 noon to April 15 at 12:00 noon and is available to the bidder group that visits the online platform at www.Power-Sellers.de on the Internet.

For this example, on March 28 at 10:41 a.m., an interested party is using the search engine available at www.google.de to find attractive travel offers on the Internet. In this process, he notices the homepage of www.Power-Sellers.de.

The interested party sees the listing of the seller V, registers and logs in with his user ID such as “Travel Guy” and his password such as “102938” on the homepage of the auction system, such as www.Power-Sellers.de.

The interested party bids on the listing of the seller at the point in time t₁ by means of the second terminal, a laptop with a wireless Internet connection. He submits his bid G1 for £249 for the weekend in Munich. The data pertaining to the bid G1 of the first bidder is transmitted from his laptop to the central computer and may be stored there redundantly, that is to say, on all of the server computers so as to create a uniform file.

At a later point in time, the bidder phones his girlfriend and tells her about the inexpensive offer of a stay from April 28 to May 1 in Munich and that he has placed a bid for it. However, the bidder's girlfriend is taken aback by the bid of the bidder and not in agreement with the bid of her boyfriend since they had both originally planned a trip to Tuscany.

Then the bidder once again visits the homepage of the online platform and retracts his bid G1 at the point in time t₂, March 28 at 1:30 p.m. The retraction of the bid G1 by the first bidder is stored by the central computer and, at the same time, the seller V is informed about the retraction of the bid G1 in that an automatic e-mail is generated by the central computer and sent to the seller.

Over the next few days, a number of interested bidders see the listing of the seller V on the Internet. However, none of them places a bid.

On April 4, at 9:17 a.m., that is to say, at point in time t₃, a second bidder, “Cheap Shopper”, reads the interesting listing of the seller “Travel Pro” and submits his bid G2 by means of the second terminal, a computer with an Internet connection via a conventional phone line. He offers £279 for the listing of the seller V. The second bidder has already been a regular customer of the online platform for two years and has made a large number of purchases via this platform. Moreover, he occasionally sells private items that he no longer needs. Over the course of the two years, the second bidder has already received 211 positive feedback points, 2 neutral ratings and no negative ratings from other buyers and sellers.

On April 14, at 11:57 p.m., a third bidder, “Auction Fox”, is surfing the World Wide Web and notices a long sought-after listing of a weekend in Munich. Since the third bidder is looking for a nice surprise for his wife's birthday, he spontaneously bids £289 for the listing of the seller V at point in time t₅ via the second terminal, a computer with a WLAN connection. The third bidder has already received 103 positive feedback points, but also 5 negative ratings from other members of the online platform at www.Power-Sellers.de.

On April 15, at 10:17 a.m., the seller V checks the response from bidders to his listing on the online platform www.Power-Sellers.de and whether he has gotten his desired selling price.

To his surprise, he sees that so far, none of the bidders has bid his desired minimum selling price of £299. At the same time, on his seller's page, he sees the retracted bid of the first bidder “Travel Guy”, the bid of the second bidder and he also sees the bid of the third bidder.

After brief deliberation, the seller decides to accept the bid of the second bidder “Cheap Shopper” (A-G2), even though the second bidder only bids £279 for the listing of the seller V, but he has considerably more positive ratings than the third bidder “Auction Fox”. So the seller V spontaneously decides to accept the bid of the second bidder “Cheap Shopper” for the listing already before the end of the auction, which would have been April 15 at 12:00 noon.

With the actively initiated acceptance of the bid by the seller V, in the embodiment described here, it is also ensured that only the bid of the bidder who meets the terms and auction conditions B1 of the seller V is accepted.

Once the seller has actively ended the auction on the homepage of his seller's page by clicking on the button “accept bid”, the central computer informs the seller as well as the bidder via e-mail about the end of the auction and the applicable contact information is exchanged.

Once the seller V has received the e-mail with the contact information such as the name, address, e-mail address of the bidder, the seller writes the bidder a short message and congratulates him for winning the auction. He writes the bidder that he has won the auction for the long weekend in Munich for the price of £279. He informs him where he can pick up the voucher for the weekend in Munich and that he would like to have payment in cash when the voucher is picked up.

The third bidder “Auction Fox”, whose bid was not accepted in this case, is informed by the central computer that the auction has ended since the bid of another bidder was accepted.

However, since the seller “Travel Pro” will frequently be auctioning off such travel arrangements for Munich, Paris and London in the future as well, the third bidder and the first bidder, who retracted his bid, will be informed about these listings if they have agreed on the bidder's page that they wish to be informed about such listings by the seller “Travel Pro”, so that they have the possibility to submit bids at a future point in time for these listings of the seller V.

At the same time, the third bidder “Auction Fox” indicates on his bidder's page that, in the future, he would like to automatically bid at specific auction conditions on listings that are similar to the one that has just ended. “Auction Fox” indicates that he would like to automatically bid for the same listing of the seller “Travel Pro” or of any other seller of the online platform www.Power-Sellers.de for a comparable weekend in Munich, up to a price of £289 during a certain period of time. The central computer then stores the listing requests of the third bidder “Auction Fox” and automatically bids for him on future auction listings that meet the auction conditions of the bidder, whereby these bids are grouped with each other. If a bid for an auction listing is accepted during this period of time specified by the bidder “Auction Fox”, then the central computer automatically retracts all of the other bids that are grouped with the successful bid. By storing this function of automatically bidding in different auctions of sellers on an online platform, the third bidder “Auction Fox” has a kind of “Auction Manager” that simply, efficiently and inexpensively follows Internet auctions and bids in auctions that meet the auction conditions specified by the bidder “Auction Fox”.

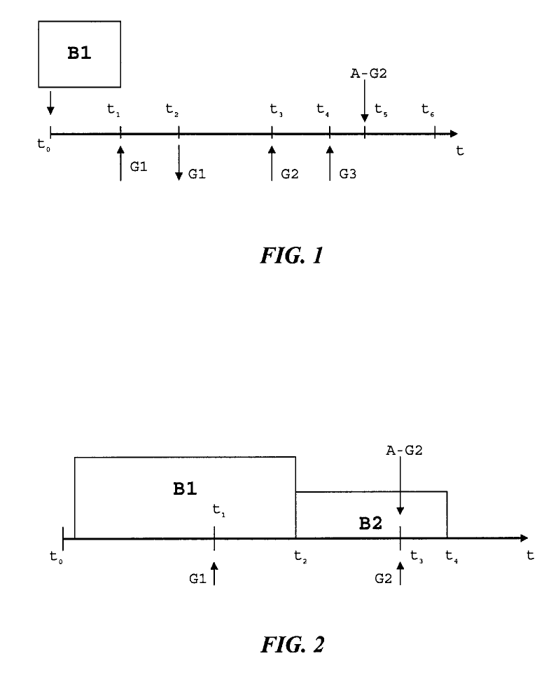

FIG. 2 shows a time course of auction conditions of a listing of an example seller called “Ride Sharer.”

The seller “Ride Sharer” places his listing at the point in time t₀, that is to say, on March 27, at 11:00 a.m., with the auction conditions B1 on the online platform at www.Power-Sellers.de.

Here, too, the seller “Ride Sharer” logs in on the homepage of www.Power-Sellers.de in the manner described above in conjunction with FIG. 1.

The seller V offers the possibility of sharing a ride from Munich to Hamburg as the auction listing. The seller would like to get an auction price of £99 for this bid. The starting price of the auction is £49.

At substantially the same time, the seller specifies the auction conditions B1 for his listing. He is looking for a male passenger who is between 20 and 29 years of age, also lives in Munich, is a non-smoker, is willing to pay £99, and has already received at least 50 positive feedback points from other members on the online platform www.Power-Sellers.de.

Here, too, as described in FIG. 1, the listing information and the auction conditions of the listing of the seller “Ride Sharer” is stored by the central computer.

The seller “Ride Sharer” then starts the auction. If a bidder bids the price of ±99 desired by the seller “Ride Sharer” and also meets the other auction conditions B1, then the central computer of the online platform www.Power-Sellers.de automatically ends the auction and the bid is accepted that first meets all of the auction conditions B1 of the seller “Ride Sharer.”

After three days, on March 30, at 7:47 p.m., that is to say, at point in time t₁, a first bidder “Cheap Rider” visits the homepage www.Power-Sellers.de and bids £49 for the listing placed by the seller “Ride Sharer.” In this case, the first bidder has the desired bidder profile desired by the seller. He already has 120 positive feedback points, is male, 25 years old, is from Munich and would like to visit his uncle in Hamburg. Moreover, the first bidder is also a nonsmoker.

Four days later, at the point in time t₂, the seller “Ride Sharer” sees that, aside from the bid from “Cheap Rider,” no other bids have been submitted for his listing. The seller is in agreement with the bidder profile of the first bidder, but the price offered so far is still too low for him to end the auction prematurely.

Then the seller “Ride Sharer” changes his auction conditions via his seller's page on the homepage of www.Power-Sellers.de by entering new auction conditions B2. These differ from the first auction conditions B1 in that the bidder can also have fewer feedback points and does not necessarily have to be from Munich; he would also take a rider from Augsburg or Nuremberg.

The new auction conditions B2 are stored by the central computer of the online platform www.Power-Sellers.de.

On April 5, at 2:27 p.m., that is to say, at point in time t₃, a second bidder “Traveler” visits the homepage www.Power-Sellers.de and submits a bid G2 for the listing of the seller that meets the auction conditions B2. The bid of “Traveler” is for £99.

At substantially the same point in time t₃, the central computer of the online platform www.Power-Sellers.de sees that the auction conditions B2 specified by the seller “Ride Sharer” have been met by the second bidder “Traveler” with his bid G2 and the central computer immediately and automatically accepts the bid, even before the actual end of the auction, which would have been April 7 at 12:00 noon, that is to say, at point in time t₅.

In response to this, the seller “Ride Sharer” and the second bidder “Traveler” are informed by e-mail about the acceptance of the bid by the central computer. At the same time, the first bidder “Cheap Rider”, who had submitted the bid G1, is informed by the central computer that his bid has not been accepted.

Nevertheless, the bidder “Cheap Rider” still needs to find a shared ride from Munich to Hamburg and goes to his bidder's page to enter that the central computer should bid automatically on all shared rides between April 1 and April 8 that meet his bidder profile and that the bids should only be placed automatically up to an auction price of £75. If his bid is accepted in one of these auctions, all of the other bids in other auctions have to be retracted again so that no further bids are accepted in other auctions. The auctions selected by the bidder “Cheap Rider” are stored by the central computer of the online platform www.Power-Sellers.de and the other bids are only retracted once a bid of the bidder “Cheap Rider” has been accepted in an auction.

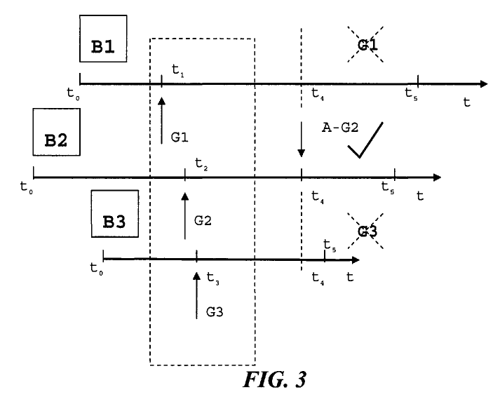

FIG. 3 shows another embodiment according to the invention.

Here, three different time axes t of three different auctions with auction conditions B1, B2 and B3 are shown.

[By the same token, FIG. 3 also shows that a bidder “Bargain Hunter” submits different bids G1, G2 and G3 within a certain window of time (rectangle shown with broken lines) to the three different auctions at different points in time t₁, t₂ and t₃. The rectangle also symbolizes the bid group that all three bids belong to.

Moreover, the point in time t₄ is shown at which the bid A-G2 of the bidder “Bargain Hunter” is accepted at the auction with the auction condition B2. The acceptance of the bid in this auction is indicated by a checkmark in FIG. 3.

FIG. 3 also shows that, after the point in time t₄, the bids G1 and G3 of the auctions with the auction conditions B1 and B3 are crossed out. Here, the bids G1 and G3 of the bidder “Bargain Hunter” for the auctions with the auction conditions B1 and B3 were automatically retracted by the central computer of the online platform www.Power-Sellers.de.

Subsequently, the ends of the auctions at the point in time t₅ are also shown, whereby these points in time differ from each other.

In another exemplary embodiment illustrated with reference to FIG. 3, at a point in time t₀, a first seller “Cheap Flights” lists a package arrangement to Tenerife for two persons, with a two-week stay in a 4-star hotel with the auction conditions B1 on the online platform of www.Power-Sellers.de. He would like to get at least £1499 in the auction for this package arrangement. At the same time, the first seller wants the bidder to have already collected 100 positive feedback points on www.Power-Sellers.de. The auction starts on March 27 at 12:00 noon and ends on April 15 at 12:00 noon.

A second seller “Travel Pro” has likewise placed an auction listing for a package arrangement to Tenerife for two persons in a 4-star hotel on the online platform of www.Power-Sellers.de. His auction conditions are that he would like to get at least £1555 for his listing. Moreover, the bidder should have received at least 50 positive feedback points on www.Power-Sellers.de from other members. The auction ends on April 14 at 11:00 a.m.

On March 29, at 12:00 noon, an auction of a third seller “Travel Auctions” starts. He, too, has offered a listing for Tenerife for two persons in a 4-star hotel. He would like to get at least £1490 for the listing and the bidder should have received at least 75 positive feedback points on www.Power-Sellers.de from other members.

For days, the bidder “Need-A-Break” has been in search of an attractive and inexpensive listing for a package arrangement to Tenerife.

On March 30, at 10:14 a.m., he comes across the listing of the first seller “Cheap Flights” on the online platform of www.Power-Sellers.de and he places his bid G1 at the point in time t₁. He places a maximum bid of £1400 for the listing since he feels that there are enough such listings on the Internet and since he thinks that he might still find a better deal on one of the other Internet auctions on www.Power-Sellers.de.

On March 31, at 3:29 p.m., the bidder “Need-A-Break” also bids on www.Power-Sellers.de for the listing of the second seller “Travel Pro” and submits his bid G2 at the point in time t₂. He also bids £1400 here.

When placing his bid for an auction of “Travel Pro”, the bidder “Need-A-Break” sets up a bid group “Trip to the Canary Islands”, in which he manually combines the first bid and his current second bid on his bidder's page of the online platform.

On April 1, at 9:29 a.m., the bidder “Need-A-Break” also notices the listing of the third seller “Travel Auctions” at www.Power-Sellers.de and bids here as well. He places his bid G3 likewise for £1400 at point in time t₃.

On his bidder's page, the bidder “Need-A-Break” likewise adds his third bid to his bid group “Trip to the Canary Islands” in that, when he creates this bid, he indicates that this bid should belong to this bid group.

The individual bids G1, G2 and G3 of the bidder “Need-A-Break” are compiled by the central computer of the online platform www.Power-Sellers.de at their corresponding bidding times and stored centrally or non-centrally on server computers.

The sellers “Cheap Flights”, “Travel Pro” and “Travel Auctions” continuously monitor the bids of other bidders for their listings of the trip to Tenerife on www.Power-Sellers.de.

The first seller “Cheap Flights” and the third seller “Travel Auctions” are not yet completely satisfied with the bids made by the bidders and by the bidder “Need-A-Break.” They would still like to wait and see whether higher bids are still submitted before the end of their auctions.

The situation is different with the second seller “Travel Pro.” He is already satisfied with the bid of £1400 submitted by the bidder “Need-A-Break” since his auctions have not been going so well recently. Therefore, the seller “Travel Pro” visits his seller's page on the homepage of www.Power-Sellers.de, logs in and ends his auction at the point in time t₄ by clicking on the button “accept bid” on the seller's page. Consequently, at the point in time t₄, that is to say, on April 3 at 2:13 p.m., the bid A-G2 of the bidder “Need-A-Break” is immediately accepted by the second seller “Travel Pro” for the package arrangement to Tenerife for two persons for £1400 in a 4-star hotel for two weeks.

At substantially the same time, the central computer that handles the Internet auctions on the online platform www.Power-Sellers.de recognizes that the second seller “Travel Pro” has accepted the bid A-G2 that was submitted by “Need-A-Break” at the point in time t₄. Then, the central computer immediately retracts the other bids G1 and G3 stored in the central computer that the bidder “Need-A-Break” had submitted to the auctions of the first seller “Cheap Flights” and of the third seller “Travel Auctions” and that he had manually added to the bid group “Trip to the Canary Islands” on his bidder's page, in order to prevent a bid from being accepted at the two other auctions of the sellers “Cheap Flights” and “Travel Auctions”. Moreover, the central computer informs the first and third sellers that the bids G1, G3 of the bidder “Need-A-Break” have been retracted.

Since the auctions of the first and third sellers end at a later point in time t₅, both of these sellers still have prospects that other bidders will submit bids at their auction and that they will get their desired auction price and that the other auction conditions B1 and B3 will be met.

The central computer of the online platform www.Power-Sellers.de also informs the bidder “Need-A-Break” by e-mail about the acceptance of his bid A-G2 of the listing of the second seller “Travel Pro.” By the same token, the second seller “Travel Pro” is informed about the end of the auction. The pertinent contact information is exchanged so that the seller and the buyer can then get into contact with each other.

### Illustrative Server Environment

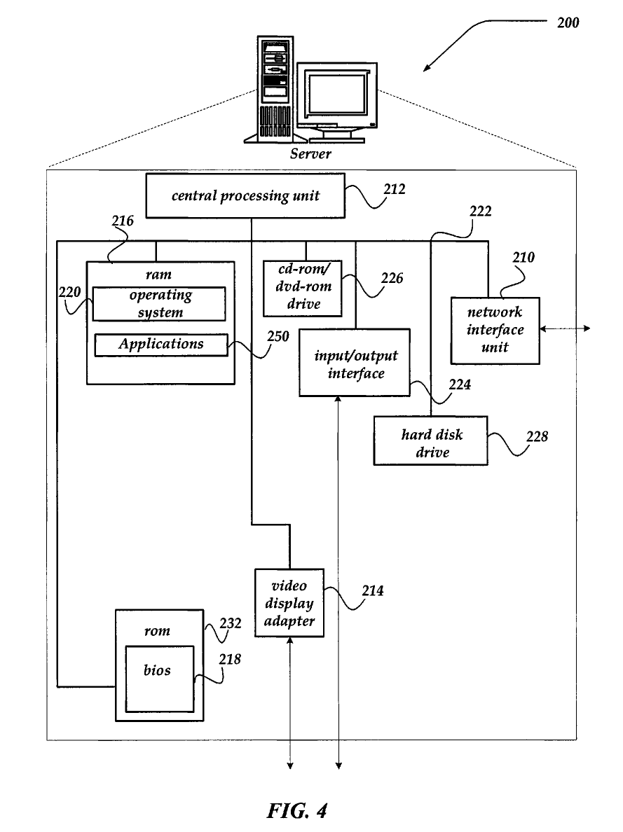

FIG. 4 shows one embodiment of a server, according to one embodiment of the invention, which uses a central computer. Server 200 may include many more components than those shown. The components shown, however, are sufficient to disclose an illustrative embodiment for practicing the invention.

Server 200 includes a processing unit 212, a video display adapter 214, and a mass memory, all in communication with each other via a bus 222. The mass memory generally includes a RAM 216, a ROM 232, and one or more permanent mass storage devices, such as a hard disk drive 228, tape drive, optical drive, and/or floppy disk drive. The mass memory stores an operating system 220 for controlling the operation of the server. Any general-purpose operating system may be employed. A basic input/output system (“BIOS”) 218 is also provided for controlling the low-level operation of server 200. As illustrated in FIG. 4, server 200 also can communicate with the Internet, or some other communications network, such as the internet, via a network interface unit 210, which is constructed for use with various communication protocols including the TCP/IP protocol. Network interface unit 210 is sometimes known as a transceiver, transceiving device, network interface card (NIC), and the like.

The mass memory as described above illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, web services, transcoders, database programs, word processing programs, spreadsheet programs, and so forth. Mass storage may also include applications such as an auction application 252, which enables auctions between sellers and bidders in various ways, such as those as described above.

Server 200 also includes an input/output interface 224 for communicating with external devices, such as a mouse, keyboard, scanner, or other input devices not shown in FIG. 4. Likewise, server 200 may further include additional mass storage facilities such as a CD-ROM/DVD-ROM drive 226 and a hard disk drive 228. Hard disk drive 228 is utilized by server 200 to store, among other things, application programs, databases, and the like.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A method for conducting an auction over an electronic network, comprising:
receiving from a seller client over the electronic network, listing information regarding an auction item;
enabling potential bidders to access the listing information and to enter a bid on the auction item for up to a predefined period of time, and
awarding the auction item to a particular bidder prior to expiration of the predefined period if an instruction is received from the seller client over the electronic network, to accept a particular received bid associated with the particular bidder.

2. The method according to claim 1, further comprising:
receiving from the seller client over the electronic network at least one auction condition to win the auction other than by a highest bid price; and
automatically awarding the auction item to the particular bidder prior to expiration of the predefined period upon receiving from a bidder client over the electronic network a bid that meets the at least one auction condition and the instruction is not received from the seller client to accept the particular received bid.

3. The method according to claim 2, further comprising ending the auction upon one of the following:
receiving an instruction from the seller client to cancel the listing information;
expiration of the predefined period without receiving any bids;
expiration of the predefined period without receiving any bids that meet the at least one auction condition and without receiving an instruction from the seller client to accept a particular received bid.

4. The method of claim 2, wherein the auction condition comprises at least one of the following: a price, a quantity, and a bidder profile.

5. The method according to claim 4, wherein the price is a minimum selling price that a seller would like to get for the auction item.

6. The method according to claim 4, wherein the quantity is one of the following:
a minimum quantity required to be purchased; and
a maximum quantity required to be purchased.

7. The method according to claim 4, wherein the bidder profile specifies characteristics of a bidder with which a seller desires to conduct the auction.

8. The method according to claim 7, wherein the bidder profile includes characteristics comprising at least one of the following: age, gender, ratings, and location.

9. The method according to claim 2, further comprising sending a message to the seller client indicating that bids have been received that do not meet the auction conditions, but the predefined period will expire within a certain time.

10. The method according to claim 1, wherein the predefined period of time starts at one of the following:
immediately upon receipt of the listing information; and
at a selectable point in time specified by a seller.

11. The method according to claim 2, further comprising determining on a random basis which of a plurality of received bids will be accepted, wherein each of the plurality of received bids are received at substantially the same time.

12. The method according to claim 1, further comprising enabling the potential bidders to enter a grouped bid for a plurality of items substantially similar to the auction item, wherein the grouped bid is applied to a plurality of substantially similar listings during the predefined period of time.

13. The method according to claim 12, further comprising automatically retracting the grouped bid if a bid grouped with the grouped bid has been accepted for one of the items substantially similar to the auction item.

14. The method according to claim 1, further comprising enabling the particular bidder to retract the bid as long as the auction item has not been awarded.

15. A computer readable medium storing computer readable instructions that cause a computing device to perform the operations of claim 1.

16. An apparatus for conducting an auction over an electronic network, comprising:
a communication interface in communication with the electronic network;
a processor in communication with the communication interface; and
a memory in communication with the processor and storing processor readable instructions that cause the processor to perform a plurality of operations including:
receiving from a seller client over the electronic network, listing information regarding an auction item;
enabling potential bidders to access the listing information and enter a bid on the item for auction for up to a predefined period of time, and
awarding the auction item to a particular bidder prior to expiration of the predefined period if an instruction is receiving from the seller client over the electronic network, to accept a particular received bid associated with the particular bidder.

17. The apparatus of claim 16, wherein the processor readable instructions further cause the processor to perform the operations of:
receiving from the seller client over the electronic network at least one auction condition to win the auction other than by a highest bid price; and
automatically awarding the auction item to the particular bidder prior to expiration of the predefined period upon receiving from a bidder client over the electronic network a bid that meets the at least one auction condition and the instruction is not received from the seller client to accept the particular received bid.

18. The apparatus of claim 17, wherein the auction condition comprises at least one of the following: a price, a quantity, and a bidder profile.

19. The apparatus of claim 18, wherein the bidder profile specifies characteristics of a bidder with which a seller desires to conduct the auction.

20. The apparatus of claim 16, wherein the processor readable instructions further cause the processor to perform the operation of enabling the potential bidders to enter a grouped bid for a plurality of items substantially similar to the auction item, wherein the grouped bid is applied to a plurality of substantially similar listings during the predefined period of time.
